(19) United States
(12) Patent Application Publication
(10) Pub. No.: US 2020/0262536 A1
(43) Pub. Date: Aug. 20, 2020

(54) BUOYANCY AERIAL VEHICLE

(71) Applicant: ATHENE WORKS LIMITED, West Yorkshire (GB)

(72) Inventor: Nicholas DEAKIN, West Yorkshire (GB)

(21) Appl. No.: 16/651,686

(22) PCT Filed: Sep. 28, 2018
(86) PCT No.: PCT/GB2018/052764

§ 371 Date: Mar. 27, 2020

(30) Foreign Application Priority Data
Sep. 29, 2017 (GB) 1715789.2

(51) Int. Cl. B64B 1/38; B64B 1/20; B64B 1/12; B64B 1/62

(52) U.S. Cl. CPC B64B 1/38; B64B 1/20; B64C 2201/042; B64B 1/62; B64B 2201/00; B64B 1/12

(57) ABSTRACT

An aerial vehicle (1) in which forward motion is developed by changing the position of the buoyancy centre and the position of the centre of gravity of the aerial vehicle (1). The aerial vehicle (1) has an envelope (12) which is a body of revolution about a central axis (X-X). The envelope (12) comprises a film and contains a lighter than air gas and wings (13, 14) one each extending laterally either side of the envelope (12).

The present application relates to an aerial vehicle. More particularly it relates to an aerial vehicle and method of flight in which the aerial vehicle is propelled by altering the buoyancy of the aerial vehicle and using the resulting rising and falling motion to produce a horizontal motion component.

Aerial vehicles require some means to maintain their altitude. Some, such as maintain altitude by buoyancy, others, such as gliders, which gain altitude on thermals and then glide down to lower altitudes using air speed to generate lift from the passage of air over its wings and control surfaces.

Unlike powered flight, where fuel must be expended to generate lift, both blimps and gliders can maintain altitude for reasonably long periods because no fuel is expended to maintain lift. Nevertheless, the time that they can spend airborne is still limited. Blimps are maintained in the air by the buoyancy of a lighter than air gas, such as helium, in an envelope; over time gas escapes from the envelope and the blimp must land to refill the envelope; additionally, fuel is needed to propel such vehicles through wind. A glider must find a source of lift such as a thermal on land—otherwise it will eventually glide down to the ground; gliders cannot operate at sea.

WO2011/117619 describes an aerial vehicle which comprises an elongate envelope having a longitudinal axis with a first compartment for holding a lighter than air gas and two air compartments for holding air, forward and aft of the first compartment. The air compartments each have an inlet and an outlet. A pair of fixed wings extend laterally from the envelope mid-way between the two ends. The wings are symmetrical about a wing axis and perpendicular to the longitudinal axis.

At launch, a lighter than air gas held in the first compartment provides excess free lift, so the aerial vehicle rises while gliding upwards and forwards using the fixed wings. As the aircraft ascends, the surrounding air becomes less dense, with the result that ascent gradually slows as the aircraft approaches its buoyancy ceiling at a height where the overall density of the vehicle is the same as the sounding air. A compressor then draws in air into the air compartments to change the overall density of the aircraft so that it is heavier than the surrounding air; it then glides downwards and forwards.

By varying the quantity of air in the front and rear compartments, the vehicle pitch can be changed. By releasing air to the atmosphere or pumping it into the front and/or rear compartments to make the vehicle lighter-than-air and glide upwards heavier-than-air and glide downwards and forwards: the process is repeated, and the aircraft follows a saw tooth flight path. Known aerial vehicles cannot quickly change pitch. Further, the volume of the air chambers does not change during the flight. This increases drag and reduces the payload carrying ability. Compared with the present inventions, the known aerial vehicle also requires substantial solar power to be able to operate, as result both payloads and endurance are limited.

According to the present invention an aerial vehicle has an envelope which is a body of revolution about a central axis in which the envelope contains a lighter than air gas disposed around a central axis and at least one air ballast chamber, the aerial vehicle having wings extending laterally from the envelope in which, in flight, forward motion is developed by changing the buoyancy of and position of the centre of gravity of the aerial vehicle characterised in that the aerodynamic centre of the vehicle is aligned with the aerodynamic centres of the wings and that the centre of gravity is maintained below the aerodynamic centre of the aerial vehicle in flight.

In an embodiment of the invention: the envelope comprises a film; a spar extends along the axis from the front of the aerial vehicle to the back of the aerial vehicle; the envelope has front and rear seals to the spar, the spar extending rearwards the back of the of the rear seal with a tail portion with the stabilisers mounted on the spar beyond the rear seal; the wings are connected to the central spar by wing mountings; a weight is movable longitudinally below the central spar from a position forward of the aerodynamic centre of the aerial vehicle to a position rearward of the aerodynamic centre of the aerial vehicle or vice-versa, in flight movement of the weight to raise or lower the nose of the aerial vehicle, the former to direct the aerial vehicle in an upward glide and the latter to direct the aerial vehicle in a downward glide; the air ballast chamber(s) are connected by a valve to the atmosphere around the aerial vehicle, air being released from the air ballast chamber to reduce buoyancy of the aerial vehicle when the aerial vehicle nose is pitched up and air being pumped into the air ballast chamber when the aerial vehicle nose is pitched down; the vehicle has an array of solar cells within the envelope to generate energy.

Other possible features and alternatives of the invention are set out in the attached claims and description.

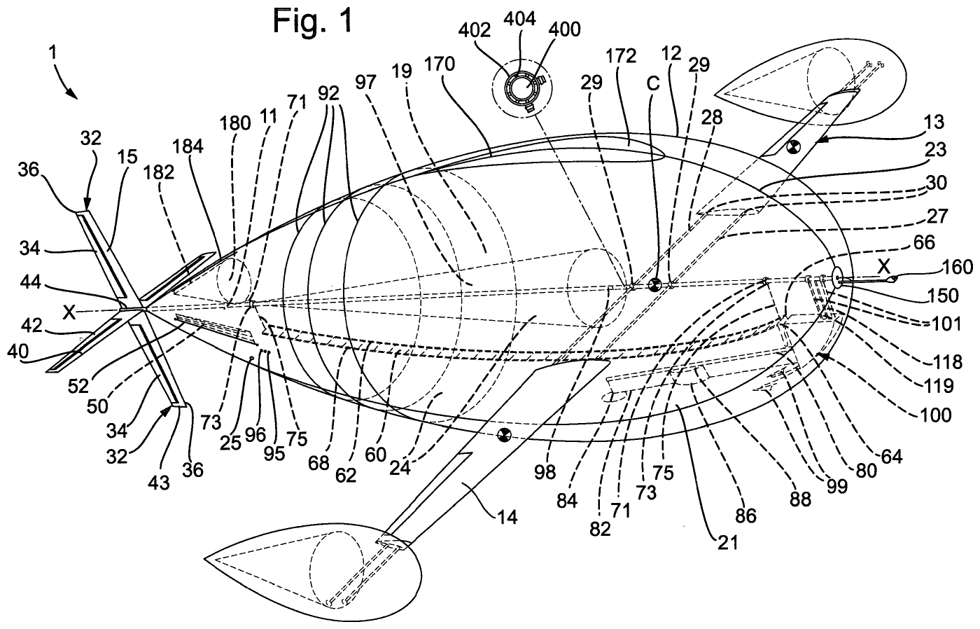

FIG. 1 is a perspective view of an embodiment of the invention;

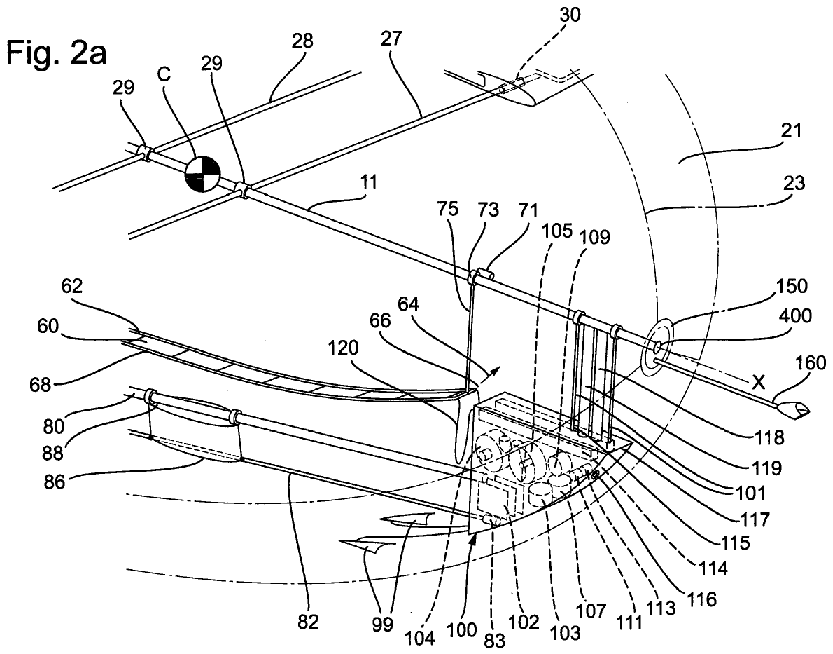

FIG. 2a is an enlarged view of the systems bay of the aerial vehicle of FIG. 1;

FIG. 2b is an enlarged view of the hand wing of the aerial vehicle of FIG. 1;

FIG. 2c is an enlarged view of the wing solar cell protective panel;

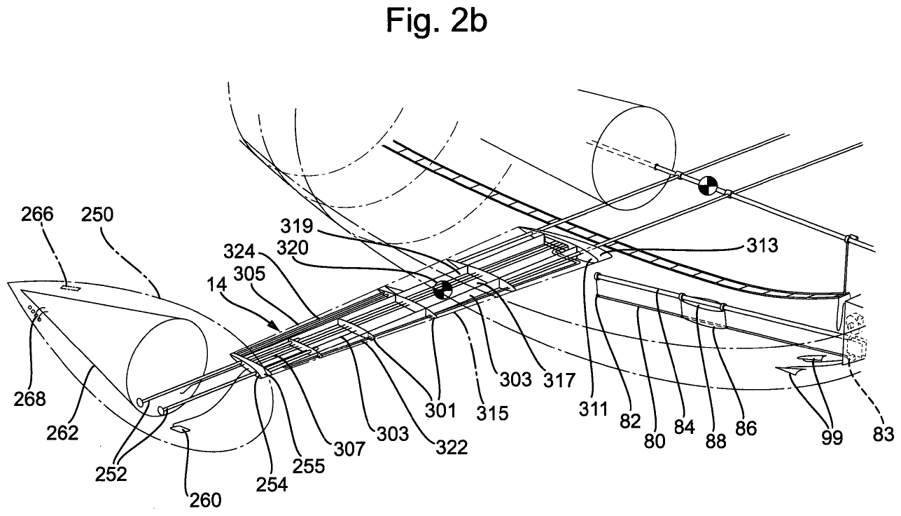

FIGS. 3a and 3b are schematic drawings of the flight of an aerial vehicle according to the invention;

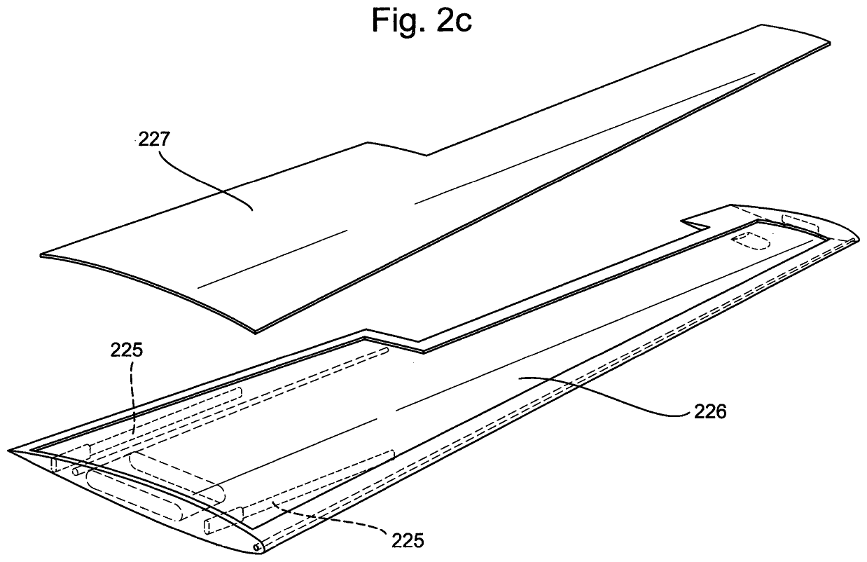

FIGS. 4a to 4d illustrate the operation of an inflatable valve in the longitudinal spar tube;

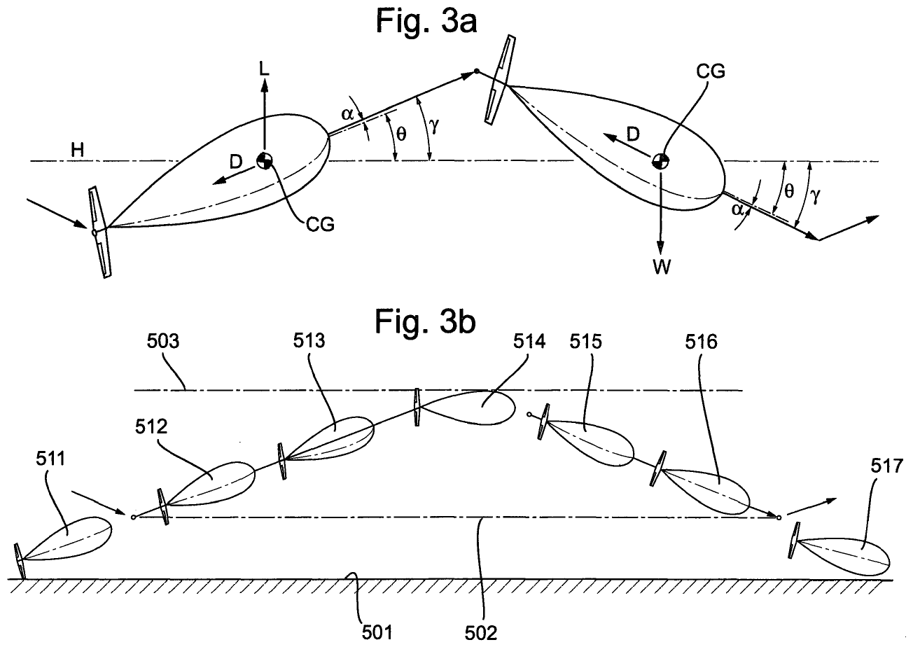

FIG. 5 is schematic cross section of the longitudinal spar and tube;

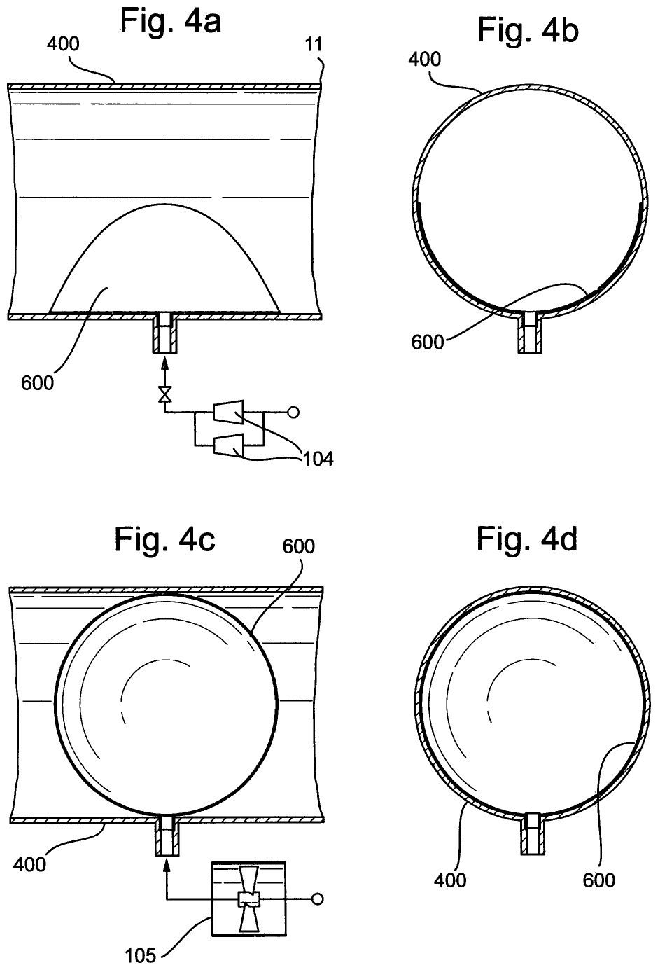

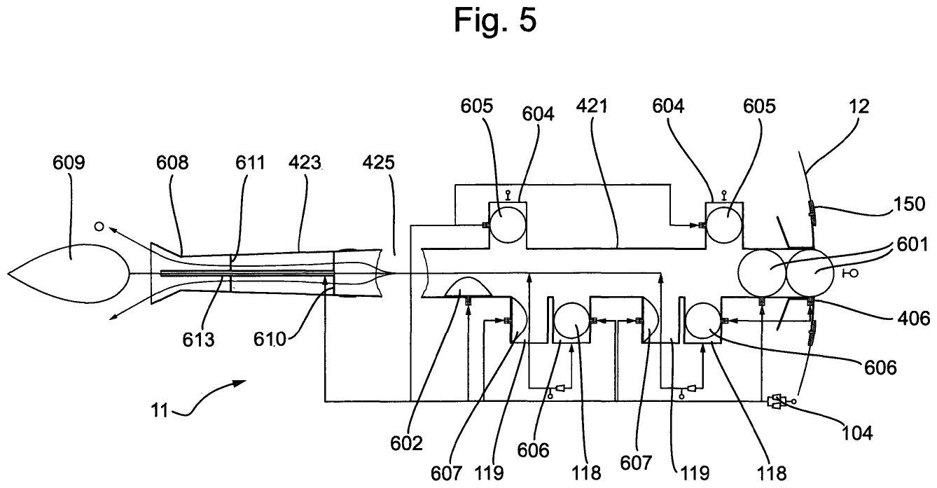

FIGS. 6 and 7 illustrate the central section of the central spar;

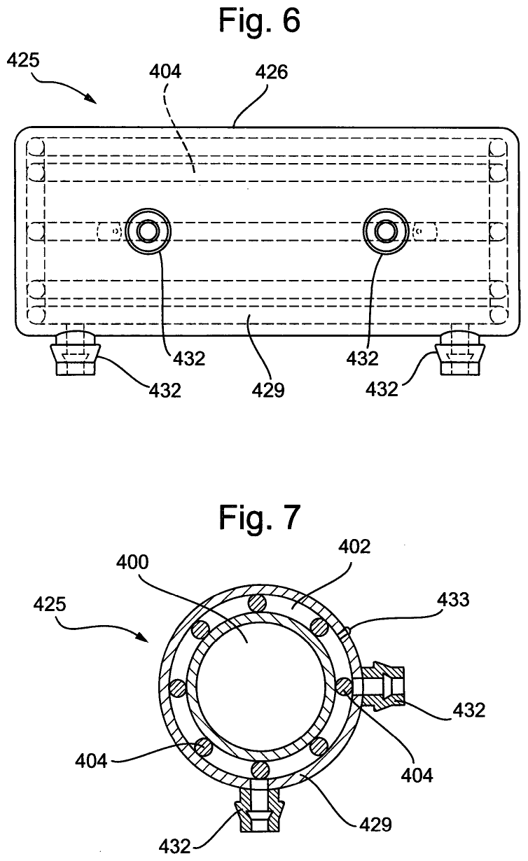

FIG. 8 is a schematic vertical section perpendicular to the central axis through the aerial vehicle of FIG. 1, showing the air ballast chambers;

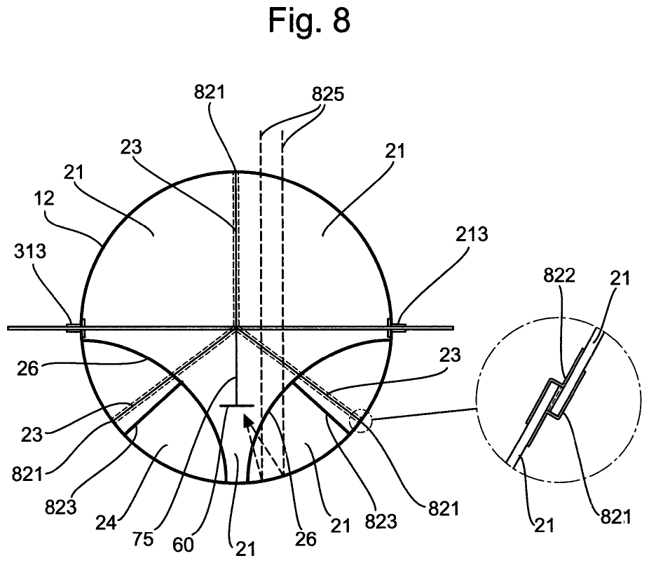

FIG. 9 is schematic section through the aerial vehicle of the invention showing the structure of the envelope;

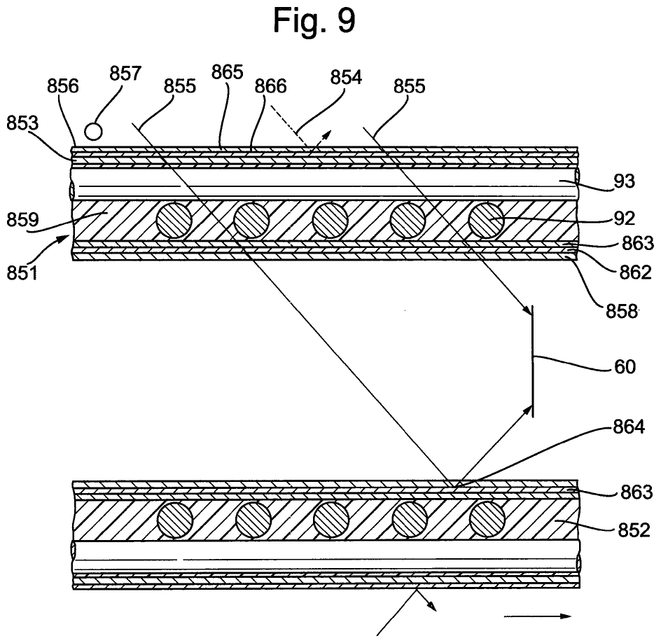

FIGS. 10a and 10b illustrate the development of a gas barrier shown in FIG. 9 as a solar cell;

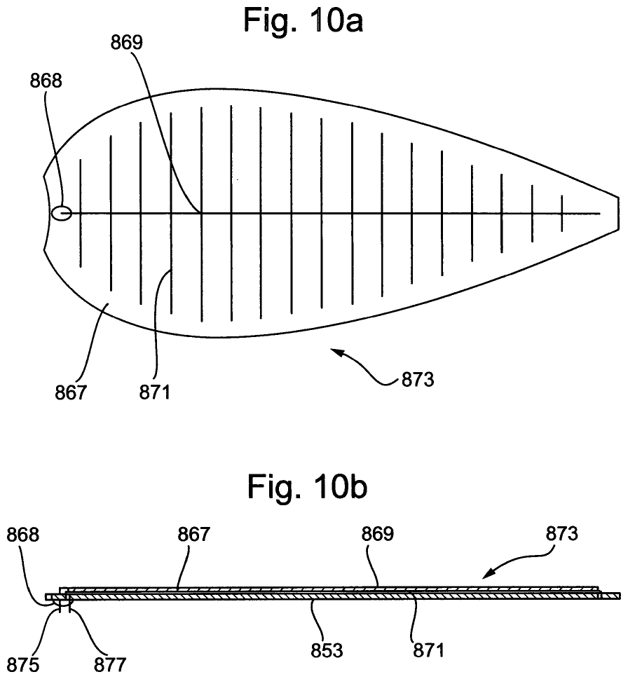

FIG. 11 illustrates a method of manufacturing panels for the envelope of the aerial vehicle;

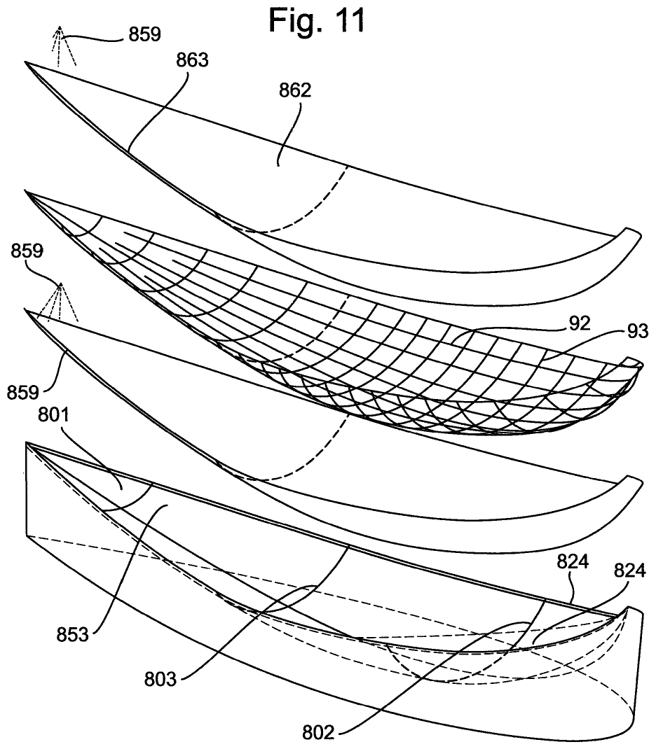

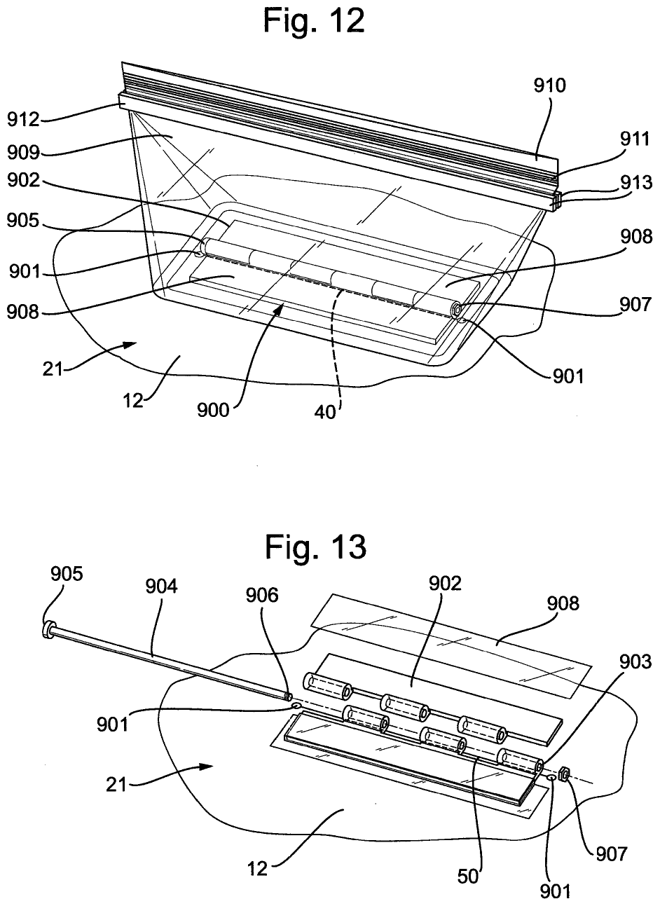

FIGS. 12 and 13 show in detail the access point for entry into the inside of the envelope; and

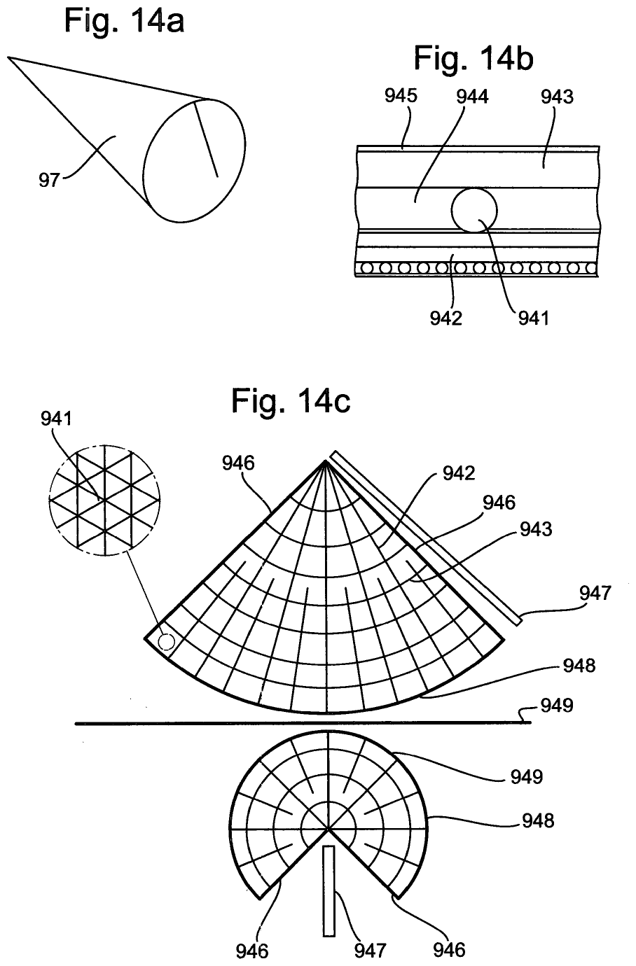

FIGS. 14a to 14c illustrate the structure of the conical storage and ballast chambers of the aerial vehicle.

In FIGS. 1 and 2a to 2c, a buoyancy aerial vehicle 1 with a longitudinal axis X-X comprises a tubular longitudinal spar 11 made of carbon fibre, a composite, or a metallic lattice with a foil skin, an envelope 12 disposed around the spar 12 which is a symmetrical aerofoil body of revolution, with wings 13 and 14 extending either side of the envelope, and a tail section 15 mounted on the spar 11 beyond the back of the envelope 12.

The envelope 12 is made up of three individual composite panels, one lower panel and upper left and upper right. The panels are joined at seams 23. The envelope may be made using a plurality of panels, however, three preferred.

The axis of longitudinal spar 11 is aligned with the longitudinal central axis X-X the aerial vehicle.

The spar 12 has a central duct 400 co-axial with the main central axis X-X, with a concentric annular duct 402, containing longitudinal micro-tubes 404. The annular duct 402 forms a heat pipe which can more effectively transfer heat to the front or rear of the aerial vehicle during ascent and descent respectively. The spar is described more fully in FIGS. 5 to 7.

In the lower part of the envelope 12 are spaced apart longitudinal left and right air ballast chambers 24 (omitted for clarity from FIG. 1 but shown in FIG. 8). A single chamber could be used, but two are preferred. Each air ballast chambers 24 has safety pressure release valves 25 and bonded to the inside of envelope 12. The ballast chambers 24 are separated from the rest of the envelope 12 by a plastic film 26, in this case Tedlar® coated with a gas barrier such as alumina or graphene.

A systems bay housing 100 is provided in the lower front of the envelope 12.

The internal volume of the envelope 12 not occupied by other items such as the ballast chambers and systems bay housing, is a helium store 19 providing buoyancy to the aerial vehicle when it is in use.

Extending laterally left and right of the main longitudinal spar 11 equidistant either side of the mean aerodynamic centre C of the envelope 12 are wing mounting tubes 27 (front) and 28 (rear), one each associated with each wing 13 and 14. The tubes 27 and 28 are threaded carbon fibre and are connected to hard mounting points 30 on the envelope 12. Each mounting hard point is a disc with tubular sections extending either side to allow gasket and jubilee clip attachments for gas sealing. The mounting points are 3D printed polymer pieces.

The mean aerodynamic centre of the envelope is indicated by C. The aerodynamic centres of the wings and envelope are aligned longitudinally.

Tubular titanium mounting connectors 29 join the mounting tubes 27 and 28 to the longitudinal spar 11.

The tail 15 has top and bottom stabilisers 32 each of a symmetrical aerofoil profile which is ideally a laminar flow aerofoil with chord thickness of less than 15% of chord length (leading to trailing edge) and being tapered from root to tip. Conductive pins 34 are provided on the trailing edges of the flight surfaces of the stabilisers 32 as electrostatic discharge pins.

Each stabiliser 32 has a rudder 36 conforming to the overall shape of the rudder in a cut out rear portion of the stabiliser. The rudders are each of carbon fibre, polymer or a micro lattice construction, controlled by a servo and mounted on a vertical tube or bar made of carbon fibre or composite. The rudders can rotate +/−45° about a vertical axis. One of the tubes 404 in the annular duct 402 of spar 1, provides refrigerant to the stabilisers 32.

Right and left stabilisers 40 extend laterally either side from the longitudinal spar 11. The left and right stabilisers are constructed in the same way as top and bottom stabilisers 32. The stabilisers are mounted on spar 11 by mountings.

Ailerons 42, conforming to the overall shape of stabilisers 40 mounted in cut outs in stabilisers 40, allow rotation of +/−45° about a horizontal axis. They can be orientated together for pitch of the aircraft or oppositely for roll and yaw control, rapidly to counter wind buffeting and maintain the desired flight path. The primary aerial pitch control is, however, by weight shift as described below to minimise drag.

The elevators are of composite carbon fibre or micro-lattices and mounted on axis pins. Control is by servo motors, Where the stabilisers 32 and 40 and associated rudders and ailerons comprise micro-lattices, these are metallic (nickel phosphorous) micro-lattice with a film skin typically of Polyvinyl fluoride (PVF) sold under the trade name Tedlar® by DuPont. Polymer micro lattices may be used in some embodiments. In addition to lightness, the micro-lattice will absorb impact energy on skid landing. Voids are provided within the structure to accommodate components such as lighting, ducts, solar cells, sensors and control surfaces.

A sealed film bladder 43 is provided in the lower rudder 32 and is a reservoir retaining a liquid (normally water) to trim the aerial vehicle in pitch and provides an additional method of weight shift to the movable weight of battery 88 in a carrier 86 discussed below. Bladder 43 is supplied through a silicon tube from another tube 404 in the annular duct 402. In the example, the bag 43 is a film of PVF and the tube silicon rubber.

Towards the rear of envelope 12, a slit 50 is provided with holes at either end to prevent split propagation. This slit 50 is sealable with a mechanical and/or magnetic seal 52 as described below. The slit 50 allows entry into the main envelope for access, component installation and maintenance.

Within the envelope 12, solar cells 60 are thermally bonded to a mounting tube 62 with epoxy resin infused with boron nitride powder, ideally around 25% by weight boron nitride, which provides excellent thermal conductivity and is dielectric. Fluid, normally water, can be passed into the tube 62 from an inlet 64 to pass along the sides of the solar cells 60 around past the rearmost solar cell and back to an outlet 66. The fluid leaving outlet 66 is passed through the systems bay housing 100 using a small pump 113 and valves to the wings 13 and 14 to provide a di-icing capability for the front of the wings of the aerial vehicle, and to dissipate heat from the solar cells.

Micro-tubes 68 run beside the solar cells 60. The micro-tubes 68 are carbon fibre or pultruded carbon fibre. Refrigerant, to gather heat generated by the solar cells 60, is passed into the tube 68 from an inlet to pass along one side of the solar cells 60 to an outlet and/or from another inlet along the other side of the solar cells to an outlet. A phase changing refrigerant is used; alcohol, ethanol, methanol and Freon are suitable. The refrigerant is vaporised by heat transferred from the solar cells and ducted to the wings (or heat venting panel 172) where it cools and condensates into liquid and is recycled by gravity. This latter may be assisted by selective engagement of a pump and/or control of valve to increase refrigerant flow from the envelope to reduce heat within and the buoyancy of the envelope during decent, and to reduce flow from the envelope and increase buoyancy during ascent of the vehicle.

Solar panel rotary actuators 71 are mounted towards the front and rear of envelope 12 on spar 11. Rotation cogs 73 are fitted to the actuators connecting to the front and rear T-shaped solar panel connector arms 75. The solar panels 60 are suspended between the solar panel connector arms 75. The actuators and cogs can rotate the solar panel connector arms, and thus the solar cells 60 in respect of the spar 11. Although the front and rear actuators 71 may be moved independently to induce a helix in the array of solar cells 60, they are normally rotated together so that the solar cells 60 are rotated about the main longitudinal spar 11 to maximise the impact of sunlight passes through the envelope 12. Transparent window panels and is reflected from a lower metallised panel 21 into the solar cells 60. In some embodiments part of the upper panels may be metallised to provide additional mirror. If it is wished to reduce the temperature of the helium gas in the envelope 12 (to increase the gases density), the actuators 71, and thus the connector arms 75, are rotated so that the plane surfaces of the solar panels are aligned as closely as possible to the direction from which the sunlight is coming to reduce to a minimum the amount falling on the solar panels.

The solar cells can be made to track sunlight through daylight hours and a small pump 113 in the systems bay 100 or valves are selectively turned on or off so that fluid heated in tube is transferred to the wings 13 and 14. Heat in the fluid is dissipated by heating and de-icing the wings. Similarly, refrigerant in the microtubes 68 (by now evaporated) is conducted to the wings, cooled and condensed. With the plane of the solar panels facing the sun, helium in the envelope is heated and its density reduced, or by turning the plane of the solar panels away from the sun the helium density is increased in light 512 or heavy 515 flight phases (see FIG. 3b).

Conventional single sided solar cells may be used, but the aerial vehicle described here employs double sided solar cells.

A guide rail 82 extends from the lower front of the envelope 12, between the air ballast chambers 24 passing below the mean aerodynamic centre C of the envelope 12 from a fixing 83 at the rear of the systems bay 100 (see FIG. 2) to a rear point 84 bonded to the envelope 12. The guide rail is carbon fibre tube impregnated with graphite or sputtered with Teflon®. A threaded bar or tube 80 is mounted above the guide rail 82 and parallel to it. A short-term energy storage compartment 86 is mounted between the threaded bar or tube 80 and the guide rail 82. Turning bar or tube 80 moves the compartment 86 to and fro on the guide rail 82 within the envelope 12. The energy storage compartment 86 contains a short-term energy storage device 88 such as lithium-Ion battery or super capacitors of graphene to provide high power densities with sufficient energy density to power at least one descent, surplus solar energy splitting water into hydrogen using electrolysis in the day and fed to fuel cells for night time operation.

As an alternative to the treaded bar or tube 80, the compartment 86 could be moved to and fro on a fixed rail by liner motors (such as piezo liner motors).

The guide rail 82 is mounted at angle of between 9° and 27° to the central axis X-X, and ideally 18°, so that the compartment 86 is constrained to move longitudinally with respect to the central axis upward or downwards at an angle between 9° and 27° and preferably 18° to the central axis X-X. This allows the overall centre of gravity of the aerial vehicle to be changed and maintained for both light (nose up) and heavy (nose down) flight phases. Critically, this allows the overall Centre of Gravity of the aerial vehicle to be positioned directly below the Aerodynamic Centre C with either positive or negative pitch angles in the range 9° to 27°. This minimises the need to engage control surfaces to deflect air (to maintain a course) that would otherwise create additional drag to maintain a desired gliding flight path and therefore the aerial vehicle may achieve significantly increased air speed in flight. It can be arranged, too that the compartment 86, or a load in the compartment can move laterally, to provide additional trim means for the vehicle.

The envelope has circumferential reinforcement fibres or filaments 92 embedded in panels 21. Longitudinal reinforcement 93 (not shown in FIG. 1 but shown in FIG. 9A) is also provided.

A helium over pressure release valve 95 also provided in the envelope with a defined release pressure to prevent over pressurisation. For normal use, however, the main envelope 12 has a controlled helium fill and release valve 96. The valve defaults to open, requiring the flight control system of the aerial vehicle to close it. If there was a system failure causing loss of power the aerial vehicle would slowly descend. The valve 96 is also used to introduce helium into the main envelope.

A conical refrigerant storage chamber 97 extends from the rearmost wing mounting tubes 28 with its base abutting tubes 28, an apex towards the rear of envelope 12. The chamber 97 stores refrigerant. The refrigerant stored as a liquid and when in gaseous state is used to provide heat transfer within the aerial vehicle typically from the solar cells 60 through tubes 62 and 68. The stored gas can also be used on ascent to replace some air ballast in chambers 24 to increase buoyancy.

The refrigerant storage chamber 97 is made up of two conical sections of film bonded back to back to form the envelope which is joined to the main spar 11 with gasket seals and jubilee clips either end. The chamber 97 is connected through inlets and outlets to the longitudinal pipes 68 running either side of the solar panels 60.

The storage chamber 97 has a liquid recovery outlet 98 is positioned at the front of the vapour storage chamber 97 so that in descent refrigerant may be recovered from the store in liquid form.

Each of the air ballast chambers 24 has a water capture pocket 99 bonded to the envelope allowing water to run over them when the ballast chambers are pressurised on descent of the aerial vehicle and capturing water on ascent. The captured water is fed to a water storage chamber 103 by pumping with a micro-pump 111 (FIG. 2a). The water storage chamber 103 provides the water supply for: solar cell cooling, mounting tube 62, night-time energy storage (when split into hydrogen) and aircraft orientation trim.

The systems bay 100, shown in greater detail in FIG. 2a, is at the lower front of the aerial vehicle between the air ballast chambers 24. The systems bay 100 is a gas tight housing but is provided with air inlets 118 and outlets 119 linking the duct 400 to the main air compressors 104 or ducted fans 105—the main compressors 104 or ducted fans 105 are used to pump air into or release air from the air ballast chambers 24.

The systems bay 100 shown also contains the flight control system and power management system each comprising a microprocessor boards 102. Included on the boards are such items as the central processing unit (CPU), Random Access Memory (DRAM), Storage (such as a Solid-State Disk), Inputs and Outputs to receive sensor input (such as temperature, pressure and GPS, accelerometers) and outputs for control of servos and compressors/pumps and on-board systems, communications board with an antenna for receiving GPS, radios and line of sight satellite communications or general interchangeable payload. To help maintain the aerial vehicle, if desired, at a fixed station at sea (which would normally be at between 1 km and 3 km altitude), a camera 116 is provided at the front of the systems bay, to be directed at a fixed object, such as a buoy.

The systems bay has a sealable opening 117 at the front and though which payloads can be inserted or removed without having to deflate the envelope. A connector is available within the systems bay to power payload equipment and share data with the flight control system.

The systems bay 100 is constructed of carbon fibre or composite sandwich board with a front transparent window for optical equipment such as camera. Load bearing tubes 101 hold the housing of the systems bay 100 in place below to the main longitudinal spar 11 and to transfer the load of the systems' bay to the main longitudinal spar 11.

The power management system receives energy input from the solar panels 60, through connections 120, short term energy battery storage 88 and the hydrogen fuel cell 114 and controls power devices such as an electrolyser 115 and compressors, and actuators of various flight surfaces and as well as controlling the rotation of the threaded bar 80, which itself controls the position of the energy storage compartment 86.

Each primary air compressor 104 or ducted fans 105 has a turbo impeller or fan, powered by an electrical motor and can incorporate a rotary encoder to meter air flow, to draw in external air through the spar 11 and pump it into either or both air ballast chambers 24. Air ballast from the ballast chamber 24 may be fed back through the impeller of the air compressor 104 or ducted fans 105 on release (gliding ascent phase) to recover energy. In this mode the air compressors now act as dynamos, thus reducing gliding ascent airspeed, as air ballast is released more slowly, however, the overall airspeed is still sufficient to penetrate average (mean) winds with improved overall propulsive efficiency. To more quickly release air ballast on ascent the compressor 104 or ducted fans 105 may be used in reverse flow for increased airspeed, however as the air in ballast chambers 24 is under pressure and it is more usually released to the atmosphere by simply opening valves 96.

One single ducted fan 105 can be used, but more usually if ducted fans are used, two or more would be in series.

Internal inflatable bladders (described in FIGS. 4 and 5) in the spar 11 and ducts can be independently inflated with small pumps 113 to act as a sealable valve.

The systems bay housing 100 also contains a refrigerant bladder 107 to store refrigerant in the aerial vehicle in a cold state. The refrigerant is used to draw heat away from heat producing components (especially the solar cells 60) and transfer this to the wings where it condenses back to liquid state.

A helium compressor 109 in the systems bay housing 100 draws helium from the main envelope 12 to and from storage in the nacelles 250 (see below). By controlling the helium pressure in the main helium envelope, up to a defined maximum, lighter weight construction may be employed in the vehicle. As the aerial vehicle temperature increases in temperature in sunlight particularly in the middle of the day (with increased pressure), some helium is removed to the nacelle helium stores 261 (see below) at to avoid exceeding the defined higher pressure.

The small pumps 113 in the main systems bay move liquids, such as water and refrigerant in gaseous and liquid states around the vehicle.

The hydrogen fuel cell 114 is a sealed container with hydrogen and air inputs to convert hydrogen fuel and oxygen in air into electrical energy and water, an internal pipe allows water to be pumped through around the solar cells to control temperature and to the wings for de-icing purposes. Separately, an electrolysis unit 115, also a sealed container, with water and electrical inputs is provided to convert water into hydrogen and oxygen, the latter is purged from the aerial vehicle. The fuel cell 114 and the electrolysis unit 115 allow a balance of hydrogen and water on-board can be maintained to meet demands, the basic supply of energy coming from the solar cells 60 and water supply from the water capture pockets 99. The electrolysis and fuel cell may be combined into a single unit to provide a reversible fuel cell.

Meta antennae, mounted on gimbals, (not shown, are mounted on the systems bay housing to for communication purposes. The gimbals would allow the antennae to be directional greatly improving bandwidth.

Two of the three panels 21 may be metallised on their inside to reflect sunlight towards the solar panels 60. The panels and the detail of the seams are discussed further in relation to FIGS. 8 and 9; the manufacture of the panels is described further in relation to FIG. 10.

The tubular elongate spar 11 has a leading-edge cap 150 with a gasket that is normally closed but when extended allows air to be taken in though the longitudinal spar tube 11. The cap is of carbon fibre with a servo provided to open it. An attitude wedge probe 160 is also provided at the front of the aerial vehicle longitudinal spar 11. The probe is a tube protruding forward at the front of the aerial vehicle into clean air flow with an expanded air intake and separated into top and bottom sections with aerodynamic funnel sections to increase the differential air pressure so that very fine angles of attack can be measured.

Atop the envelope 12 on the outside surface is an envelope cooling chamber foil 170 forming a chamber 172 between the foil 170 and the envelope 12. The chamber 172 has inlets and outlets (omitted for clarity). The inlets and outlets are configured to admit liquid refrigerant to the chamber 172 to vaporise it in the chamber 172 and expel the vapour, and/and to admit gaseous refrigerant to condense it in chamber 172 and to expel the condensed liquid. Vaporisation will occur during light ascending conditions, and to condensation of refrigerant in descending conditions. Normally, the chamber 172 receives vaporised refrigerant from the micro-tubes 68 and the condensed refrigerant is returned to the micro-tubes 68 to cool the solar cells 60. The refrigerant store chamber 97 may be used as a buffer. The vaporisation cycle is a passive system, the condensing cycle can be assisted with micro-pumps where required on the inlet and/or outlet. The chamber foil 170 has a seal 176 around its perimeter bonded to the envelope 12 so the chamber 172 is gas and liquid tight. The seam 176 is further over bonded with a film reinforcement section running all around the edge of the foil 170, leaving the central part of the foil 170 exposed to the air through which the aerial vehicle might be travelling. A similar chamber to that shown may also be provided in which water circulating within the aerial vehicle is condensed.

An auxiliary hydrogen storage chamber 180 is located at the rear of the envelope 12 inside the top; this comprises back to back conical sections of film bonded together to form the chamber, UHMWPE (Ultra High Molecular Weight Polyethylene and is transparent), carbon fibre or carbon nanotube filament reinforcement is encapsulated in the film that may be metallised to form a gas barrier. A film 182 extends from the envelope 12 to the storage chamber 180 to keep it suspended.

An aperture 184 with a palladium foil filter is provided on the top of envelope 12 near the hydrogen storage chamber 180. This allows hydrogen present in the envelope 12 to escape but prevents the passage of helium.

To avoid further complicating FIG. 1 not all ducts and conduits are shown but the presence of appropriate ducts and conduits will be very apparent form the descriptions of the function of the various other components in FIG. 1.

The main purpose of the hydrogen is as energy store for use at night when no solar energy is available. It is taken from the various hydrogen stores on board the aerial vehicle stores in the aerial vehicle to the hydrogen fuel cell 114 where it is combined with oxygen from the atmosphere to generate electricity.

During the day the process is reversed with some of the electrical power being generated from the solar cells 60 being used to electrolyse water in the electrolysis unit 115, to release hydrogen which is then pumped to the on-board storage facilities. The hydrogen in store also provides additional buoyancy to the aerial vehicle and can be used to replace lost helium.

The structure of the right wing 14 is shown in detail in FIG. 2b. Wing 13 is a mirror image.

The right wing 14 has a wing ribs 301 conforming to the shape of the wing and laser cut from sandwich boards having carbon fibre faces and an aluminium honeycomb core. It is a laminar flow symmetrical aerofoil with ideally 15% or less thickness to chord length. They have slots to interlock with tapered wing spars 303. An aileron 305 operated by a servo and mounted on tubular spars on pivots is inserted in the trailing edge of wing 14.

The wing 14 is covered in a transparent film 309. This is a transparent polymer such a Tedlar®. An anti-reflective coating is sputtered onto the film to improve light transmission to solar panels follow by a sputtered hydrophobic coating.

A port 311 rebated within a wing spacer section 313 allows liquid and gas pipes to be connected either side of the port while providing a gas tight seal either side. The spacer section 313 allows the envelope (body of revolution) and wing (tapered profile) to mate, the spacer is of foam.

The leading edge of wing 14 has an aileron plate 315 conforming to the wing profile. It is also made off carbon fibre sandwich board. The aileron 315 is pivotally mounted and moved by actuators is a conventional way. A solar panel or panels 317 is set into a cavity between wing ribs 303. For this purpose, flexible high efficiency cells such as the triple junctions provided by MicroLink Devices Inc. of the USA are preferred.

320 indicates the wing aerodynamic centre of wing 14, which typically for a laminar flow aerofoil is 40% of the chord length (front to back) and around 25% for a standard symmetrical aerofoil such as NACA. In both cases about equal areas of the surface of the wing 14 are on either side.

A wing de-icing pipe 322 with water as the operating fluid passes along the front edge of the wing 14; this pipe 322 is connected through the port 311 to duct 62. A refrigerant de-icing pipe 324 with inlet and outlet passes along the rear of the wing 14; this is connected through the port 311 to refrigerant micro-ducts 68.

At the end of the wing 14 is a wing tip nacelle 250 mounted on wing tip nacelle mountings 252 of carbon fibre or protruded carbon tube rear wingtip supported in a nacelle mounting plate 254 with a spacer section 255. The mountings 252 are bonded to plates 256 in the inside of the envelope of nacelle 250.

Three flexible helium silicon tubes 307 passes through the wing 14 to its end and to nacelle 250.

One of the tubes 307 connects to a bladder 260 of PVF (Tedlar®) for the storage of water or refrigerant. This water or refrigerant provides weight to trim the aerial vehicle to the correct roll orientation without needing to employ control surfaces.

The nacelle 250 has a conical hydrogen store 262 with connected the second tube 307 to the main hydrogen store 97, and in which role it could act to trim the aerial vehicle. This hydrogen store 262 comprises back to back conical sections of UHMWPE filament reinforcement encapsulated into film that may be metallised with alumina to provide a gas barrier.

Inner volume of nacelle 250 unoccupied by other components forms a nacelle helium store 261, which is connected to the main helium store 19 by the third of the tubes 307.

The nacelle has a spacer section 255 which is of foam or carbon fibre lattice with a plate section 254 for communication of liquids and gases and including front mounting plate bonded to the envelope of nacelle 250 with a protruded threaded section to fit to the mounting 252.

An aperture 266 with a palladium foil filter is provided in the upper surface of the nacelle 250 to allow any escaped hydrogen to pass from the nacelle. This allows such hydrogen to be to be vented to atmosphere and to keep the helium chamber hydrogen free.

A hydrogen fill valve 268 is connected to the hydrogen store 262, and a blow-off valve 270 allows excess hydrogen to escape from the store 262. A nacelle helium fill valve 272 allows helium to be introduced to and evacuated.

The envelope of nacelle 250 constructed in the similar way to the main envelope 12 and comprises a film polymer such a Tedlar® that may have a hydrophobic coating that is sputtered onto the film to provide an anti-reflective coating to improve light transmission to solar panels.

Pins of aluminium or copper can be provided on the trailing edge of the wing provide for discharge of electrostatic build up.

In FIG. 2c, a wing is shown with an array of solar panels 225 mounted in an insert 226 in the wing. To mitigate, this risk the solar panels 225 and the insert 226 have a solar transmitting cover 227.

FIGS. 3a and 3b show the typical flight pattern of an aerial vehicle as shown in FIG. 1.

In FIG. 3a, α is the angle of attack which normally is +/−0.1° or less when ascending or descending, Θ is the aerial vehicle attitude and y the flight path angle, H is a horizontal datum line and CG the centre of gravity of the aerial vehicle.

In FIG. 3b, 501 is the ground and 503 the buoyancy ceiling, namely the point at which the aerial vehicles overall density is the same as the density of the surrounding air, which is typically 3 km above sea level, although it maybe high or lower depending on the particular parameters of the aerial vehicle's construction.

Initially the aerial vehicle is on the ground 501, in FIG. 3b, with air ballast chambers fully pressurised and the helium chamber (and the nacelles) fully pressurised with helium, the weight of air in the air ballast chambers 24 preventing ascent. Air is released from the air ballast chambers 24, at the same time, the storage compartment 86 (in FIG. 1) is also moved rearwards. The aerial vehicle rises beginning its ascent as the buoyancy of helium now lifts the craft and with the centre of gravity now moved backwards, the nose of the aerial vehicle rises (511 in FIG. 3b). The overall centre of gravity of the vehicle remains aligned with the aerodynamic centre of the vehicle in gliding ascent (nose up) or gliding descent (nose down) achieved by weight shift usually by moving the compartment 86 or possibly moving water to trim the aircraft for the desired gliding angle.

As ascent continues (512 in FIG. 3b) further air is released and the helium in the envelope 12 is kept the same pressure as in the air chambers to maintain the shape of envelope. This continues (513 in FIG. 3b) towards the buoyancy ceiling 503, where almost all the air has been released from the ballast chambers, although a small amount may be retained to ensure a small pressure differential between that inside the aerial vehicle and the surrounding atmosphere. In this way the envelope is fully inflated throughout the ascent.

At this point (514 in FIG. 3b) when the buoyancy ceiling is reached, the storage compartment 86 is moved forward and the aerial vehicle levels out before the nose dips and descent commences with air being pumped into the air ballast chambers to retain the small pressure differential between pressure in the aerial vehicle and the surrounding atmosphere (515 in FIG. 3b). This continues (516 in FIG. 3b) with the aerial vehicle now moving in equilibrium on a downward slope until the minimum desired height, the nadir 502 is approached. The storage compartment 86 is moved backwards and air once again pumped from the air ballast chambers 25, the nose rises, and the aerial vehicle once again ascends.

This flight pattern can be repeated indefinitely.

If it is wished to land the aerial vehicle on the ground 501, descent continues instead until the aerial vehicle approaches the ground when the battery is moved closer to but not as far as a position as below the mean aerodynamic centre (C in FIG. 1) of the aerial vehicle, so that it has an attitude of about 9° nose down (517in FIG. 3b) reducing the airspeed. By adjusting the air ballast and flying into the wind, the air speed is reduced further; the aerial vehicle is then captured in a net or it skids onto the ground. More air is pumped into the air ballast chambers to keep it on the ground.

The arrangement described allows the envelope to be fully inflated throughout the flight cycle for its pressure to be close but slightly above the surrounding air pressure at the buoyancy ceiling (ideally 5 milli atmospheres but up to 20 milli atmospheres above surrounding air pressure at the buoyancy ceiling). As a result, the compressor 104 or ducted fans 105 uses significantly less power to draw in air to increase the ballast weight for decent. Between the buoyancy ceiling 503 and the nadir 502 the aerial vehicle attitude is around 18° nose down or nose up depending on whether the aerial vehicle is in normal descent or ascent, in a range of between 9° and 27°. Obviously at around the ceiling 503, nadir 502 and approaching the ground 501 the attitude will be less than this.

To help buoyancy, fluid flow though pipe 62 and micro-tubes 68 (in FIG. 1) can be stopped on the ascent leading to heating of the solar panels 60 and the helium or other lighter than air gas in the envelope 12. At the same time or instead the solar panels 60 (in FIG. 1) can be rotated to maximise the amount of sunlight falling on the solar panels.

In the aerial vehicle shown in FIGS. 1 and 2, the spar 11 has a central air flow tube 400. FIGS. 5a to d show an inflatable valve used to control air flow through the central tube 400. FIGS. 4a and 4b show an inflatable valve 600 partly inflated in tube 400. The inflatable valve 600 is connected to main air compressors 104 in the systems' bay housing as shown in FIG. 4a; as an alternative to using air compressors, ducted fans 105 (as in FIG. 4c can be used, these can more easily be used to regenerate energy of their speed can be varied, and they can be reversed easily. Air is pumped into the inflatable valve 600 wholly to fill the tube 400 as in FIGS. 4c and 4d, blocking flow through the tube 400.

In FIG. 5 a schematic view of the air flow arrangements through the tube 400 in spar 11 is shown. FIG. 5 only shows the front 0.5 metre or so section 421 of the spar 11 and the rear section 423 of around 0.35 metres in length. The section 425 between the front 421 and rear 423 sections of the spar 11 is bridged by concentric tubing as illustrated in FIGS. 6 and 7. Inflatable valves 600 shown in FIGS. 4a to 4d are found in the front 421 section of the spar 11.

The spar 11 is connected to the outer envelope 12 by the leading-edge hard plate 150. The entrance to tube 400 is shown as 406.

Immediately behind the entrance 406 to tube 400 is a pair of inflatable valves 601 which can be inflated using pumps 104 or ducted fans 105 to seal the entry to tube 400 when needed. Shown to the left of the valves 601 at the top of the tube 400, are two helium dump ducts 604 normally closed by inflatable valves 605. When the valves 605 are deflated should it be necessary to provide a rapid route for releasing helium form the envelope 12 into tube 400 is provided. In this way very, small lightweight valves and micro compressors can be used to open and close gas ducts that have a large aperture for rapid movement of gases.

At the bottom of tube 400 are the air ballast inlet ducts 118 with the corresponding air ballast outlet ducts 119. Passage of air through each inlet and outlet duct is controlled by inflatable valves 606 (ducts 118), and 607 (ducts 119). Moving towards the left of the front portion 421 of spar 11, a further inflatable valve 602 is shown in duct 400, which when inflated prevents air travelling out of the left of the tube 400. In appropriate circumstances, say normally stable ascent, air leaving air ballast chambers 24 can be directed through the impellers of compressors 104 to generate electricity. If ducted fans 105 are used instead of compressors 105, the fans are reversed to generate electricity. In situations where air is being released rapidly from the air ballast chambers, such as in transition from decent to ascent, the valve 602 would be open allowing air to escape to the left of the tube 400.

The left-hand section 423 of tube 400 is formed as a Venturi 608 with a pressure operated plug valve 609 in its outlet. The plug 609 is mounted in skeleton frames 610 and 611 in the Venturi 608. Air pressure from air compressors 104 or ducted fans 105 would open the plug valve 609; release of pressure closes the plug under the action of a spring 613. Closure of plug valve 609 prevents flow through the Venturi 608.

For clarity the stop control valves in the lines leading from pumps 104 or ducted fans 105 to the various inflatable valves and the Venturi plug are omitted.

The valves 601 and 607 can be operated in several ways in different circumstances depending on their degree of inflation:
Simply allowing air ballast to escape from the vehicle, this requires no energy;
Feeding released air ballast through the compressor 104 or ducted fans 105 to recover energy, increasing overall efficiency but slowing air speed;
Feeding air ballast through the compressor 104 or ducted fans 105 which are powered to run in reverse to more quickly reduce ballast enabling faster airspeed but uses more power. This configuration would be avoided normally however is available for urgency.

In FIG. 5, the central section 425 of the spar 11 was omitted. The central section 425 is constructed of one or more concentric tubular sections 426 as shown in FIG. 6 (and in cross section in FIG. 7). The length of the illustrated section has been shortened for illustrative purposes, but in the aerial vehicle of FIGS. 1 and 2, the central section 425 is normally about 10 meters long and, for ease of manufacture it is made up in shorter sections as shown in FIG. 6, each section being 2 to 3 metres long, the shorter sections being joined together.

The shorter sections 426 are concentric with the central air tube, having a second concentric tube 402 annular in cross section around. The outer tube 402 contains water and water vapour 429. Within the annular outer tube and extending longitudinally along the length of the section 425 are micro-tubes 404 having inlets and outlets 432. The micro tubes 404 are connected by their inlets and outlets to water or water vapour and to refrigerant (or its vapour) which has been heated by the solar panels 60 (FIG. 1). The water and water vapour on the one hand and refrigerant and its vapour on the other are connected to different micro tubes. The water or water vapour and refrigerant pass along the micro tubes 430 from the front of the section 426 towards the rear, and in doing so vaporise water 429 in the annular tube 402. The heat from the vaporised water is conducted through the wall between the annular tube 402 and the central tube 400, heating air passing along tube 400. As this air, at height, will have come from the cool atmosphere surrounding the aerial vehicle it will cool the water vapour in annular tube 402 so condensing, in that way some of the heat generated by the solar panels is dissipated. The annular tube 402 is thus a heat pipe.

The outer annular tube 404 is close ended as are the micro tubes 430. It is therefore practicable to join individual section using an internally threaded sleeve (not shown), engaging with external filaments at the end of each section. PTFE tape or resin glue is used to make the treads air tight to prevent air from the tube 400 leaking into the helium contained in the envelope 12. Adjoining sections of micro tubes are joined by connect the outlets 432 of the micro tubes in a forward section to the inlets 432 of the micro tubes in the next ear section.

FIG. 8 is a schematic vertical section through the envelope 12 of the aerial vehicle of FIGS. 1 and 2. The envelope 12 is made up of three composite panels 21 bonded together to form a body of revolution with an aerodynamic profile envelope. In the aerial vehicle examples of FIGS. 1 and 2, the envelope aerofoil is a NACA 0030 with 30% thickness to chord length; however, any symmetrical aerofoil may be employed. In an alternative embodiment, when the thickness is reduced below 15%, a laminar flow aerofoil shape is used. The panels 21 are joined at seams 23. The seams 23 are normally ultrasonically or heat welded but can overlap and be bonded together with a resin system or with flexible glue, with over bonded film sections 821 on the outside of the composite. These overlapping bonded film sections 824 may also have a further internal over bond film 822 as shown in the cut-out of FIG. 8. Pairs of the panels 21 could be bonded together with a clear transparent resin system using overlapping seams. The films 821 and 822 are a thermo-plastic polymer.

Also, in FIG. 8 the outline of the air ballast chambers 24 of FIG. 1 can be seen together with solar cells 60 below connection arm 75. The ballast chambers 24 have an internal member 823 in the form of a film to restrain their expansion to prevent contact with the solar cells 60.

The internal surface of the lower panel 21 is reflective, to reflect light 825 entering the envelope 12 of aerial vehicle onto the solar panels 60 as shown by the dashed lines.

FIG. 9 shows a schematic cross-section of two panels 851 and 852 which are illustrative of panels 21 comprising the envelope 12 of the aerial vehicle of the invention. It is emphasised that FIG. 9 is purely schematic and in practice separation of the panels is much greater than apparent in FIG. 9.

The upper panel 851 comprises an outer film 853 and inner film 862, of Tedlar® of 6-50-micron thickness.

The outer film 853 has an anti-reflective coating 866, an X-ray and dichromic filter 865 to reflect light below 285 nm and light above 285 nm 855 to pass, and a gas barrier coating 867. A thin super hydrophobic coating 856 can be applied to the outer film 853 by spraying a one or two-part system after construction or as part of routine maintenance, such systems are commercially available from Aculon Inc., or Ultra Ever Dry. The coating allows precipitation 857 to more quickly run off the envelope reducing overall weight in rain.

The inner film 862 may include a metallised coating 863 of alumina to provide a gas barrier coating that is light transmissive allowing 90% of incoming light to pass, onto the photovoltaic cells 60. The gas barrier coating may be alumina applied by chemical vapour deposition (CVD) or of graphene (preferred) by example applied by CVD or mechanical deposition by rubbing graphite onto the film surface or deposition of graphene nano-platelets held in solution (such as water and boiled off). Then mechanically pressed to improve adhesion of the deposited material to the film. The provision of the photovoltaic cells within the envelope allows the use of multi-junction solar cells based on III-V semi-conductors, which are highly crystalline that would otherwise shatter on hail impact, if exposed to the elements as is the case on prior art aerial vehicles.

The films 853 and 862 encapsulate longitudinal reinforcement filaments 93 and latitudinal reinforcement filaments 92 embedded in an ultra violet stabilised resin layer 859, such as polyurethane. The reinforcement filaments are, ideally, UHMWPE and commercially known as Spectra™ or Dyneema™, however, any suitable reinforcement may be used. To ensure an outer surface of the envelope 12 which is free of undulations across the direction of flight, it is important that the longitudinal reinforcement fibres 860 are outside the latitudinal reinforcement fibres 861.

An alternative material for the films 853 and 862 is Cuban™ composite cloth supplied by Cubic Corporation.

The bottom panel 852 is the same as the top panel 851 above but in reverse order. On the bottom panel 852, the metallised coating 863 may be a thicker deposition of 1-3 microns of alumina or silver where required to provide a mirror 864, to reflect light 855 onto photovoltaic cells 60.

FIGS. 10a and 10b show a further development of a gas barrier coating 867 of graphene into a solar cell. Before applying the gas barrier layer 867, one or more of the envelope panels, normally those on the upper of the envelope and which are substantially transparent are coated with a bottom contact 871 onto the transparent film 853. A contact grid 869 (for example gold) is deposited through a mask using chemical vapour deposition or by inkjet printing a conductive ink and then electro plating. Tin or tin oxide may be applied to the film using method known in the art of flexible electronic fabrication; this creates a central spine with contacts extending either side of the centre line.

The central spine is thicker, typically 1 cm, to carry high power, with less than 1 mm wide pathways extending either side and a typical pitch between pathways of 1 cm. In some embodiments the spine and contact grid may be tapered to carry higher powerboats (not shown). The graphene 867 is then applied by chemical vapour deposition to a few atomic layers thickness. Alternatively graphene platelets may be applied in solvent such as water and evaporated off to leave a coating of graphene platelets onto the film with a thickness of a few atomic layers. Additionally graphene can be applied by rubbing a monolithic block of graphite across the film. A top contact 871 is then deposited, using a similar method to contact 869; this may be either deposited in the same position as shown or offset typically to half the pitch between extended contacts. In this way a graphene photovoltaic cell 873 is formed.

Electrical connections 875 and 877 are provided through the film 853 and 862, and soldered to the contact grids 869 and 871 respectively. A seal 868 is applied so the film onto holes through the films so that the films are gas tight, the seal is typically a dielectric such as an epoxy resin. The graphene layer 867 and electrical contacts could also be provided between the outer film 853 and resin layer 859. The electrical connections 875 and 877 provide electrical power from the graphene photovoltaic cell 872 formed as above to the power management board 102 in the systems bay. This method may be used for both of the films 853 and 862 forming a composite envelope panel because the graphene layer 867 is only a few atoms thick, the majority of sunlight passes straight through, about 15% of photons that hit the carbon atoms of graphene are converted to electrical energy.

FIG. 11 illustrates the manufacturing process to construct the three panels 21 of FIG. 1 that are bonded together to form a complete envelope 12.

A former 801 has been manufactured with a female shape onto which films and re-enforcement filaments are applied. The internal profile of the former 801 as of part of the outside of the aerial vehicle with the profile is swept around a radius 802 of the longitudinal axis X-X of the aerial vehicle of FIGS. 1 and 2. The former's 801 swept arc 803 will, therefore, be the radius 802 multiplied by 360° and divided by the number of panels plus the width of two overlapping sections 824 (as seen in the cut-out of FIG. 8) typically 20 mm wide each. The former 801 is typically milled from a block; glass fibre cloth is laid onto this with a polyester resin with a gel coat to provide a smooth surface finish. A release wax is then applied to the surface of the former 801.

The outer film 853 of Tedlar®, of 6-50-micron thickness fineness, which may have an anti-reflective coating 865, an X-ray and dichromic filter 866, with a gas barrier coating 867, is first applied into the former 801. A heat source is applied to soften the film so that it drapes to conform to the profile of the former.

Individual filaments are then laid with a large format computer numeric control machine, having at least 3 axis filament feeds with shears. In the case of this invention, a 6-axis robot arm on a track was employed. The longitudinal filaments 93 are first laid; some run the full length of the former and others laid short of the full length because less longitudinal reinforcement is required towards the leading edge and trailing edges when the envelope is pressurised for this application. The latitudinal reinforcement filaments 92 are next laid down around the arc of the former; the density of reinforcement filaments 92 is highest at the widest part of the envelope. The latitudinal reinforcement filaments 92 are is laid from half the width of the overlapping seam 824 on one edge side of the outer film 853 to half the width of the overlapping seam (23 in FIG. 1) on the other edge of the outer film 853. Not all the latitudinal or longitudinal filaments need to extend fully across the width or length respectively of the former 801, dependant on the potential loading forces to be applied to the envelope 12 in operation.

An UV resin layer 859 is then sprayed over the film and reinforcement elements. The inner film 862 is then applied. The inner film 862 which also may include any required coatings, such as the metallised barrier or optical coating 863. The inner film 862 is heated to soften it so that it conforms to the profile of the former. Like the outer film 853, the inner film's width includes an overlap 824.

A bag is then placed around the edge of the former 801 with gas tight gum seal and subjected to a vacuum, squeezing the composite tightly together. An ultra-violet light source is then applied to fully cure the resin layer 859 and bond the panel thus made. If needed a self-repairing resin layer 858 can be applied within the sandwich film composite.

The completed panel is then bonded to adjacent panels with an ultrasonic welder to form the completed envelope 12. The outside of the completed envelope 12 is then sprayed with the thin super hydrophobic coating 856 shown in FIG. 9.

The envelope described here has a distinct advantage over existing envelopes for lighter than air vehicles, particularly for this application where air drawn into or expelled from the air ballast compartments within the envelope is used to effect an overall density change to propel the craft forwards in heavier than air state. The reinforcement, being directly aligned with the shortest loading pathway, is optimised for the loading forces encountered around the circumference and longitudinally from leading to trailing edge thereby retaining the aerodynamic shape and volume.

FIGS. 12 and 13 show a general arrangement relating to operation and closure of the maintenance slit 50 in figure lwhich allows access into the envelope 12 to enable the installation, upgrade and maintenance of internal components within the envelope. Normally the slit 50 in the main envelope 12 is towards the rear of the aerial vehicle of FIG. 1. in lower panel 21. The slit 50 has rounded holes 901 at either end to minimise the risk of rip propagation. A coupling 900 is provided to close the slit 50 when the aerial vehicle is in use. The coupling 900 comprises interlocking coupling members 902 bonded to the panel 21 either side of the slit. The interlocking portions are formed in the same way as hinge members with an aperture 903 formed through the interlocking portions.

The coupling 900 is 3D printed using stereo lithography of a photo curable polymer that may be impregnated with carbon nanotubes (2.5% by weight).

A shaft rod 904 of pultruded carbon fibre and having a dead stop 904 at one end and an external thread 906 at the other is inserted down the length of the aperture 903 interlocking couplings member 902 and held with a fixing 907 gripping the end 906 of rod 904. Ideally, the aperture 903 is tapered to ease insertion of the rod 904. A reinforcement film 908 normally of the same material as the envelope 12 film is applied over each interlocking coupling member 902. The coupling 900 thus formed allows forces to be transferred across the slit 50.

A film loop 909, normally of the same material film as the envelope film but 10-100-micron thickness, has an opening 910, with the constituent members of an interlocking grip seal 911 bonded to the film loop 909 either side of the opening 910. The film loop 909 is bonded to the panel 21 of the envelope completely around the opening slit 50. Normally, the bonding is by ultrasonic welding, however, a resin system can be used. A magnetic coupling 912 is positioned just below the grip seal. The two individual magnetic members 913 of the magnetic coupling 912 mounted opposite one another the film.

The magnetic members 913 have interlocking profiles which co-operate to squeeze the film loop 909 through a serpentine path.

In this invention the interlocking neodymium magnetic members 913 are 3D printed using a photopolymer to provide plurality of extended interlocking teeth 914. The separation of the teeth is ideally the same as the portions of the loop film captured between the teeth; i.e. twice the film thickness. The serpentine pathway for the film loop created by the teeth 914 provides a further gas tight seal that resists air entering through the opening slit 50. Occasionally, although wind gusts might apply air pressure through the slit 910 that could break the interlocking grip seal gas seal 911; the magnetic members 913 of the magnetic coupling 912 can withstand this.

FIGS. 14a to 14c illustrate the manufacture of the conical chambers shown in FIG. 1, for example the hydrogen storage chambers 97, 262 and the air ballast chambers 24. As one example, a hydrogen storage chamber 97 is made up from a base layer 941 of Cuban™ composite cloth supplied by CubicTechnologiesCorporation of the USA, laid as a segment of a circle with an arcuate edge opposite the point of the centre of the segment. UHMWPE Reinforcement fibres 942 and 943 are laid on the Cuban composite cloth both longitudinally and on arcs perpendicular to the longitudinal fibres as in FIG. 14c. The composite cloth itself has a triangular arrangement of fibres 941 as seen in the insert in FIG. 14c. A resin layer 944 is set around the fibres 942 and 943, and a covering film 945 applied. The edges 946 are heat welded together to form a seam to form the conical structure illustrated by the hydrogen storage chamber 97 shown. If necessary, the seam can be reinforced by a further overlaying film 947, the edge 948 can also be reinforced by a film 949.

The other conical chambers are made in the same way as storage container 97.

The reinforcement as described enables lightweight chambers that can withstand high gas pressures up to ten atmospheres however in this vehicle the maximum is usually seven atmospheres to maintain the density of stored hydrogen below the likely surrounding atmosphere.

The purpose of the solar cells is to provide power to the on-board compressors, ducted fans, electrical and electronic equipment. Heat from the solar cells can be used to increase the buoyancy of the aerial vehicle during ascent as described. In some designs, a hydrogen fuel cell 114 alone is sufficient to power the aerial vehicle; in such a design an additional black sheet could be incorporated in the envelope, the black sheet being turned to expose the plane black surface to the sun during ascent of the vehicle and turned away so that the edge is towards the sun in decent, the heating of the black surface in ascent providing added buoyancy. In this configuration, the fuel cell would be recharged using captured water and solar energy garnered from solar panels on the wings of the vehicle.

Although not shown in the drawings, double sided solar panels could be used, with a mirror beneath the solar panel array to reflect incoming solar energy onto the lower side of the array. Alternative an double sided array of solar panels could be deployed in the V formed between a pair of mirrors at an angle to one another.

This specification describes features which can be incorporated into the aerial vehicle. These features may be incorporated alone or in combination with other features appropriate to the application.

1. An aerial vehicle having an envelope which is a body of revolution about a central axis in which the envelope contains a lighter than air gas disposed around a central axis and at least one air ballast chamber, the aerial vehicle having wings extending laterally from the envelope in which, in flight, forward motion is developed by changing the buoyancy of and position of the centre of gravity of the aerial vehicle wherein the aerodynamic centre of the vehicle is aligned with the aerodynamic centres of the wings and that the centre of gravity is maintained below the aerodynamic centre of the aerial vehicle in flight.

2. An aerial vehicle according to claim 1 wherein: the envelope comprises a film; a weight movable longitudinally below the central spar from a position forward of the aerodynamic centre of the aerial vehicle to a position rearward of the aerodynamic centre of the aerial vehicle or vice-versa, in flight movement of the weight to raise or lower the nose of the aerial vehicle, the former to direct the aerial vehicle in an upward glide and the latter to direct the aerial vehicle in a downward glide; and the air ballast chamber(s) are connected through a valve to the atmosphere around the aerial vehicle, air being released from the air ballast chamber to reduce buoyancy of the aerial vehicle when the aerial vehicle nose is pitched up and air being pumped into the air ballast chamber when the aerial vehicle nose is pitched down.

3. An aerial vehicle according to claim 2 in which the upward glide and the downward glide are between +9° and +27° to the horizontal (upward glide) and between −9° and −27° to the horizontal (downward glide).

4. An aerial vehicle according to claim 3 in which the weight is mounted to move longitudinally at an angle of between 9° and 27° degrees to the central axis.

5. An aerial vehicle according to claim 2 wherein: a spar extends along the axis from the front of the aerial vehicle to the back of the aerial vehicle; the envelope has front and rear seals to the spar, the spar extending rearwards the back of the of the rear seal with a tail portion with the stabilisers mounted on the spar beyond the rear seal; the wings are connected to the central spar by wing mountings.

6. An aerial vehicle according to claim 3 wherein having at least two air ballast chambers disposed either side of a vertical plane through the spar.

7. An aerial vehicle according to claim 5 wherein the spar has a central axial duct.

8. An aerial vehicle according to claim 7 the duct extends from the front of the aerial vehicle to the rear, the duct having an opening to the surrounding air at the both the front and rear of the aerial vehicle, and in which valves are disposed in the duct to selectively close entry for air into the duct and/or to prevent air or other gas leaving the duct.

9. An aerial vehicle according to claim 7 wherein one or more passages join the duct to the at least one ballast chambers and though which air may pass into the at least one air ballast chamber, the said passage(s) having a valve to close the passage and at least one further passage connect the at least one air ballast chamber back to the duct through which air may leave the air ballast chambers, said further passage(s) having a to open the further passage(s).

10. An aerial vehicle according to claim 7 in which the duct has one or more connections to the inside of the envelope to release lighter than air gas from the inside of the envelope into the duct, at least one valve being in each connection to control or prevent the flow of gas from the envelope.

11. An aerial vehicle according to claim 7 wherein the spar comprises a concentric tube around the duct, the concentric tube being closed and containing water or refrigerant, to form a heat pipe.

12. An aerial vehicle according to claim 11 wherein the water or refrigerant is heated and vaporised in the outer tube by heat from within the envelope and cooled by contact with the duct and air flow through the duct.

13. An aerial vehicle according to claim 11 wherein concentric tube additionally contains pipes to conduct fluids and control signals to the tail.

14. An aerial vehicle according to claim 1 wherein the air ballast chamber(s) have an internal member restraining over expansion.

15. An aerial vehicle according to claim 1 wherein solar cells are located within the envelope and in that the envelope is at least in part transparent to radiation of the wavelength at which the solar cells operate.

16. An aerial vehicle according to claim 15 wherein the solar cells are mounted on a duct through which liquid may flow.

17. An aerial vehicle according to claim 16 wherein liquid heated by or vapour created by the solar cells is ducted to the wings.

18. An aerial vehicle according to claim 1 wherein heat in the lighter than air gas is cooled to reduce buoyancy of the aerial vehicle and heated to increase buoyance of the aerial vehicle.

19. An aerial vehicle according to claim 1 wherein having a thermally conductive panel on the outside of the envelope to cool or heat liquid which is passed by the solar panels.

20. An aerial vehicle according to claim 1 wherein, at the buoyancy ceiling of the vehicle, pressure in the air ballast chamber(s) is greater than the surrounding atmospheric pressure but less than 20 milli atmospheres above atmospheric pressure on ascent and the pressure of the lighter than air gas is the same as the pressure in the air ballast chamber(s).

21. An aerial vehicle according to claim 20 wherein at the buoyancy ceiling of the vehicle the pressure in the air ballast chamber is 5 milli atmospheres above atmospheric pressure on ascent.

22. An aerial vehicle according to claim 1 wherein it has nacelles attached to the wing tips, the nacelles providing additional storage of lighter than air gas.

23. An aerial vehicle according to claim 22 wherein each nacelle has a bladder to which water can be passed to provide additional trim capability of the aerial vehicle.

24. An aerial vehicle according to claim 22 wherein in which each nacelle has a hydrogen storage chamber.

25. An aerial vehicle according to claim 1 wherein the envelope contains embedded longitudinal and latitudinal filaments or fibres, the longitudinal reinforcement being outside the latitudinal reinforcement.

26. An aerial vehicle according to claim 25 wherein the reinforcement fibres are held in a resin between an outer film and an inner film.

27. An aerial vehicle according to claim 25 wherein the envelope comprises a plurality of individual panels extending from the front to the rear of the envelope with overlapping portions at the edges of the panels.

28. An aerial vehicle according to claim 1 having a graphene layer on the envelope formed as a solar panel.

29. An aerial vehicle in which forward motion is developed without thrust by changing the buoyancy and position of the centre of gravity of the aerial vehicle, the aerial vehicle having an envelope which is a body of revolution about a central axis wherein the envelope comprises a film and contains a lighter than air gas, the envelope having lateral wings extending each side of the envelope wherein the envelope contains embedded longitudinal and latitudinal filaments or fibres, the longitudinal reinforcement being outside the latitudinal reinforcement.
